(19) United States
(12) Patent Application Publication
(10) Pub. No.: US 2021/0083420 A1
(43) Pub. Date: Mar. 18, 2021

(54) OPENING SEALING MEMBER AND ELECTRICAL DEVICE

(71) Applicant: Sumitomo Wiring Systems, Ltd., Yokkaichi, Mie (JP)

(72) Inventor: Takeru Miyamoto, Yokkaichi, Mie (JP)

(21) Appl. No.: 16/603,215

(22) PCT Filed: Apr. 2, 2018
(86) PCT No.: PCT/JP2018/014069

§ 371 Date: Oct. 4, 2019

(30) Foreign Application Priority Data
Apr. 7, 2017 (JP) 2017-076928

(51) Int. Cl. H01R 13/52; H01R 13/512

(52) U.S. Cl. CPC H01R 13/5213; H01R 13/512; H01R 2201/26; H01R 13/5202; H01R 13/5227

(57) ABSTRACT

An opening sealing member 10 is for closing an opening 91 for work open in a vertical direction and includes a cover plate 20 configured to cover the opening 91 from above and a plug body 40 held on the cover plate 20 and including a sealing member 45 to be held in close contact with an inner peripheral surface of the opening 91 by the plug body being fit into the opening 91. An upper surface 21A of the cover plate 20 is provided with a gradient to cause water adhering to the cover plate 20 to flow down to outside of the cover plate 20. An upper surface 51A of the plug body 40 is provided with a gradient to cause water adhering to the upper surface 51A of the plug body 40 to flow down to outside of the opening 91.

### BACKGROUND

Field of the Invention. The invention relates to an opening sealing member for sealing an opening for work and an electrical device using this opening sealing member.

Related Art. A terminal block for connection to an external circuit is provided inside a case of an electrical device installed in an automotive vehicle or the like and the case is provided with an opening for work to perform an operation of connecting this terminal block and the external circuit. This opening is closed by a sealing cover (opening sealing member) when the operation is not performed. An example of such a sealing cover is disclosed in Japanese Unexamined Patent Publication No. 2012-236450.

This sealing cover includes a sealing ring holding member and a cover body. The sealing ring holding member is made of synthetic resin and has a sealing ring fit on an outer peripheral surface. The sealing ring is to be fit into an opening provided in a metal case that accommodates an electrical device and is held in close contact with the inner peripheral surface of the opening. The cover body is made of metal and is mounted on a surface of the case. A shaft provided in the sealing ring holding member is inserted into an insertion hole provided in the cover body and is bolted together with a retaining means so that the cover body and the sealing ring holding member are fixed.

In the configuration of Japanese Unexamined Patent Publication No. 2012-236450, water intrudes into a gap between the cover body and the sealing ring holding member since the insertion hole is open in the cover body. If this water stays without being discharged, the cover body and the like made of metal may be corroded.

### SUMMARY

This specification discloses an opening sealing member for closing an opening for work open in a vertical direction. The opening sealing member includes a cover plate configured to cover the opening from above. A plug body is held on the cover plate and includes a sealing member to be held in close contact with an inner peripheral surface of the opening by the plug body being fit into the opening. An upper surface of the cover plate is provided with a gradient to cause water adhering to the cover plate to flow down to outside of the cover plate, and an upper surface of the plug body is provided with a gradient to cause water adhering to the upper surface of the plug body to flow down to outside of the opening.

Water splashed on the cover plate flows down from the cover plate and does not stay on the cover plate since the upper surface of the cover plate is provided with the gradient. Further, water intruding between the cover plate and the plug body also flows down from the plug body to the outside of the opening since the plug body is provided with the gradient. Thus, the water does not stay between the plug body and the cover plate. Therefore, corrosion by the intruding water can be suppressed.

The upper surface of the cover plate and the upper surface of the plug body may be provided with the gradients in the same direction. Since the water on the cover plate and the intruding water between the plug body and the cover plate flow down in the same direction, the flowing-down water can be dealt with easily.

A boss may project on the plug body and may be used to screw a bolt for fixing the plug body to the cover plate. The plug body may have an elliptical shape in a plan view and the upper surface of the plug body may be provided with a first plug body gradient in a longitudinal direction and a second plug body gradient in a transverse direction. A lower end position of the first plug body gradient may be shifted in the longitudinal direction from a position where the boss portion is provided. The boss portion projects on the plug body and could hinder discharging water. However, since the lower end position of the first plug body gradient provided on the upper surface of the plug body is shifted in the longitudinal direction from the position where the boss is provided, water will not stay on a peripheral edge of the boss.

An electrical device using the opening sealing member disclosed in this specification may be configured as follows.

The electrical device may include an opening sealing member, a terminal, a wire connected to the terminal and a housing configured to accommodate the terminal and provided with an opening for work. The opening may be closed by the opening sealing member. Lower end positions of gradients provided on upper surfaces of the cover plate and the plug body are located on an end part opposite to a side where the wire is pulled out.

By discharging water toward the side opposite to the side where the wire is pulled out, the splash of the discharged water on the wire and the like can be suppressed.

According to the opening sealing member disclosed in this specification, splashed water can be discharged to outside.

### BRIEF DESCRIPTION OF DRAWINGS

FIG. 1 is a plan view of an opening sealing member in an embodiment.

FIG. 2 is a back view of the opening sealing member.

FIG. 3 is a section along in FIG. 1.

FIG. 4 is a section along IV-IV in FIG. 1.

FIG. 5 is a plan view of a connector.

FIG. 6 is a side view in a state before the connector and the opening sealing member are assembled.

FIG. 7 is a side view in a state after the connector and the opening sealing member are assembled.

### DETAILED DESCRIPTION

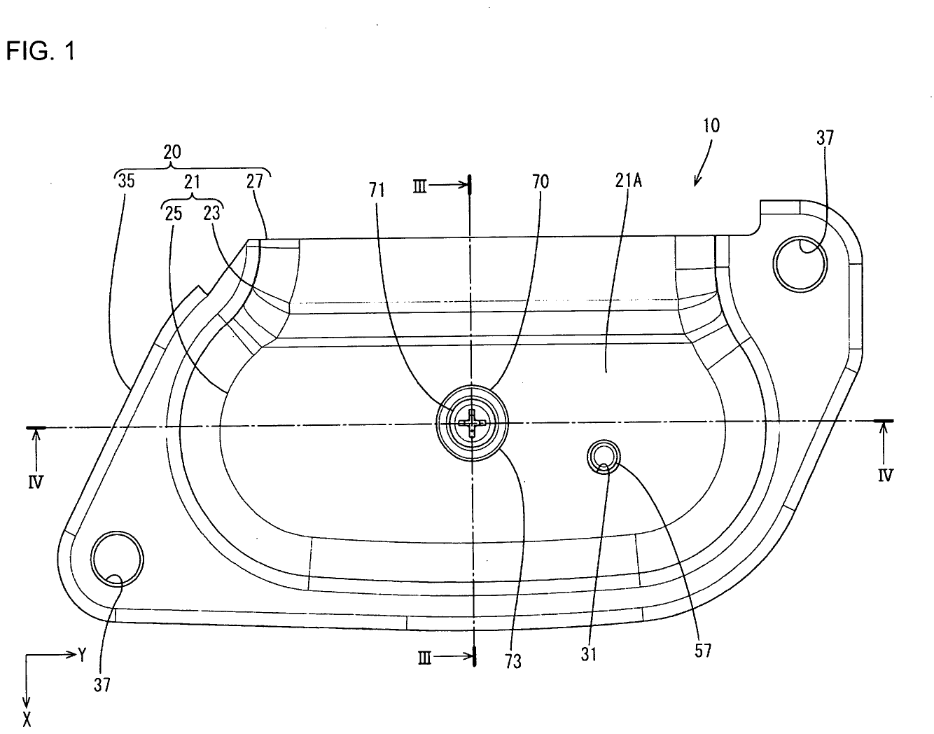

An embodiment is described with reference to FIGS. 1 to 7.

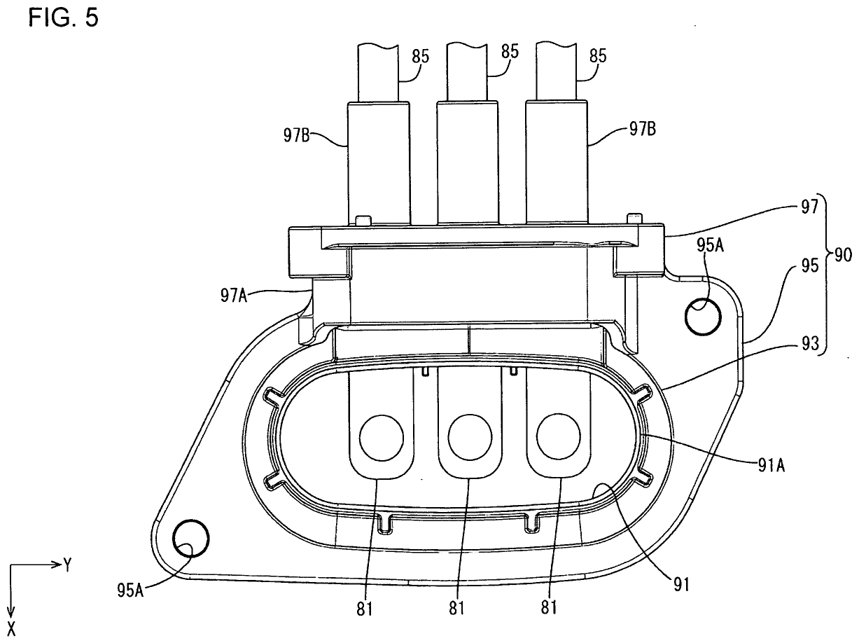

An opening sealing member 10 of this embodiment is for closing an opening 91 for work of a connector 80 (an example of an “electrical device”) mounted on a shield case of a device such as a motor or inverter installed in a vehicle as shown in FIGS. 5 to 7. In the following description, a Z direction is an upward direction concerning a vertical direction, an X direction is a forward direction concerning a front-rear direction and a Y direction is a rightward direction concerning a lateral direction.

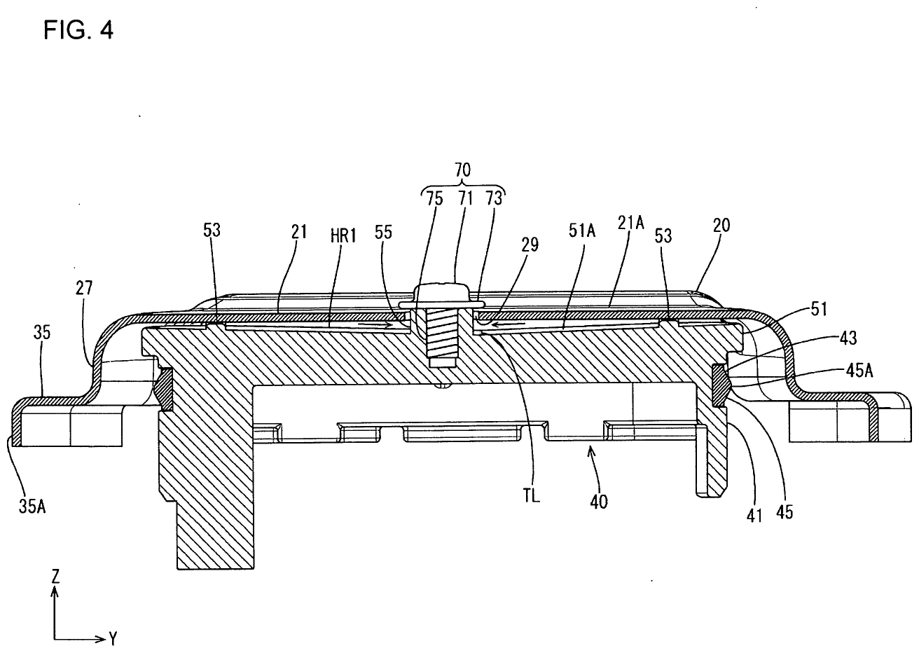

As shown in FIGS. 4 and 5, the connector 80 is connected to an unillustrated terminal block provided in the shield case. The connector 80 includes terminals 81 made of conductive metal, wires 85 connected to the terminals 81 and a housing 90 made of synthetic resin and accommodating the terminals 81 and end parts of the wires 85.

The terminal 81 is bent into an L shape to extend downward after being connected to the wire 85 and further bent into an L shape in a lower end part of the housing 90 to project into an opening 91 of the housing 90. Three terminals 81 are insert-molded to be arranged in the lateral direction in the housing 90, and connected to mating terminals held on the terminal block.

The housing 90 includes a tubular housing body 93 provided with the opening 91, a flange 95 in the form of a flat plate projecting out from the housing body 93 and a wire holding portion 97 projecting rearwardly of the housing body 93 and configured to hold the wires 85. The opening 91 is open in the vertical direction and has an elliptical shape long in the lateral direction in a plan view. A lower end part of the opening 91 is fit to the terminal block, whereas an operation of connecting the terminals 81 and the mating terminals of the terminal block is performed with the opening 91 open upward. When the connecting operation is not performed, this opening 91 is closed also on an upper side by the opening sealing member 10. Further, the flange 95 is provided with bolt insertion holes 95A through which bolts for fixing the shield case and a cover plate 20 of the opening sealing member 10 to be described later are inserted. The wire holding portion 97 includes an integral holding portion 97A for integrally holding connected parts of the terminals 81 and the wires 85 and hollow cylindrical individual holding portions 97B for individually holding the wires 85. The integral holding portion 97A projects further upward than the housing body portion 93. The wires 85 are pulled out rearward from the wire holding portion 97.

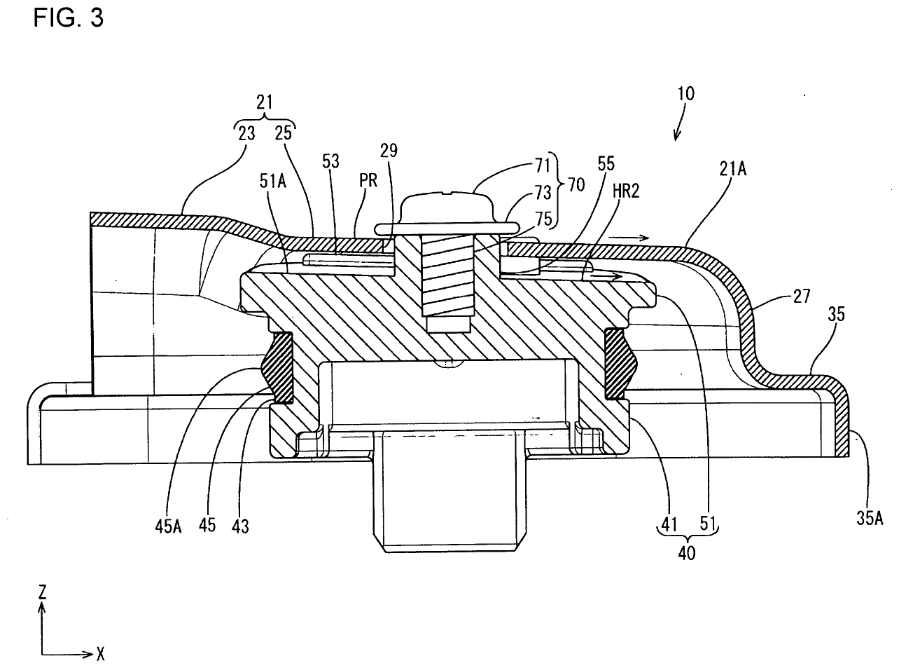

As shown in FIGS. 1 and 3, the opening sealing member 10 includes the cover plate 20 and a plug body 40, and the cover plate 20 and the plug body 40 are fixed by a tap screw 70.

The tap screw 70 includes a circular head 71, a circular ring 73 having a larger diameter than the head 71 and a screw 75 capable of cutting a thread. An outer diameter of the ring 73 is larger than a diameter of an insertion hole 29 of the cover plate 20 to be described later, and the ring 73 is retained by being locked to an edge 29A of the insertion hole 29.

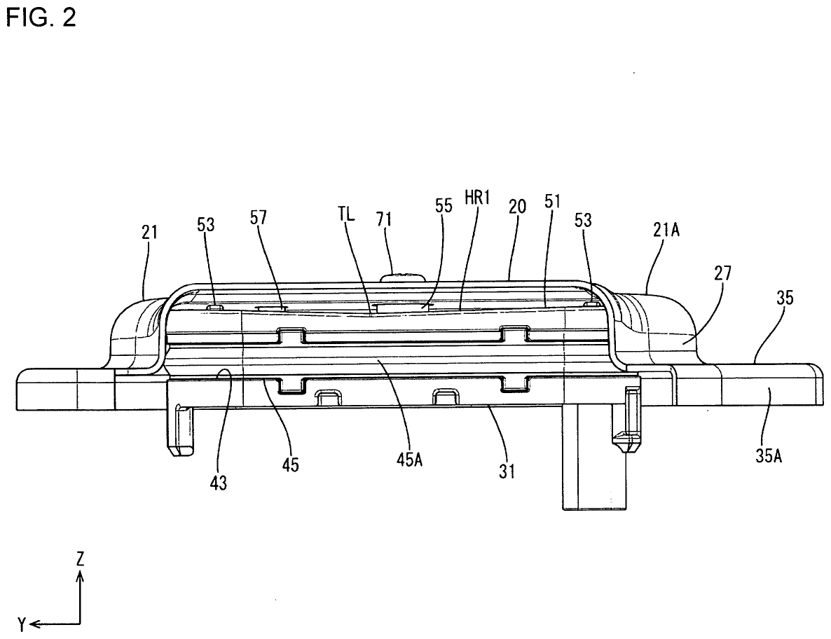

The cover plate 20 is formed by press-working a metal plate, such as a steel plate, and includes, as shown in FIGS. 1 and 2, a plate body 21 for covering the opening 91 and the wire holding portion 97 of the connector 80, a mounting portion 35 for covering the flange 95 of the connector 80 and a link 27 for linking an end part of the plate body 21 and the mounting portion 35. The link 27 links the plate body 21 and the mounting portion 35 by a rounded shape and a vertical surface. The cover plate 20 is in the form of an inverted shallow dish having a rectangular shape and capable of covering the opening 91.

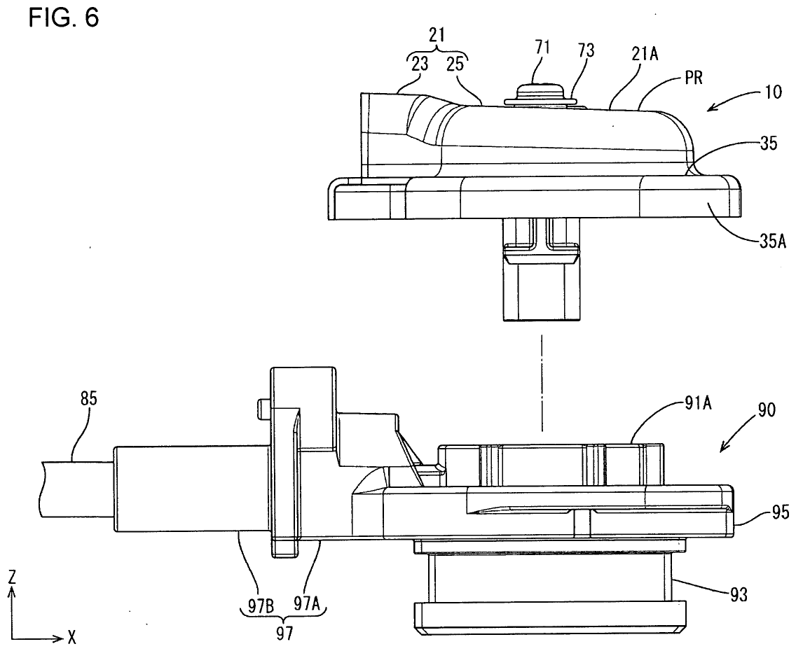

As shown in FIGS. 3 and 6, the plate body 21 includes a housing cover portion 23 configured to cover the integral holding portion 97A of the wire holding portion 97 from above, and a plug body cover 25 for covering the plug body 40. The housing cover 23 is open rearward, and a width (lateral dimension) thereof gradually becomes larger toward the front. The plug body cover 25 has the same outer shape as the plug body 40 and is slightly larger external dimensions than the plug body 40. The circular insertion hole 29 into which a boss 55 of the plug body 40 to be described later is insertable is provided in a laterally central part of the plug body cover 25. The insertion hole 29 penetrates in a plate thickness direction of the plate body 21. Further, the lower surface of the ring 73 of the tap screw 70 comes into contact with the edge 29A of the insertion hole 29. Further, a circular pin insertion hole 31 into which a positioning pin 57 of the plug body 40 to be described later is insertable is provided to the right of the insertion hole 29.

An upper surface 21A of the plate body 21 is provided with a plate gradient PR so that a rear end is highest and a front end is lowest. A degree of the plate gradient PR partially differs, but a gradient is constant in the plug body cover 25 of the plate body 21. Further, the upper surface of the plate body 21 is constantly lower on a front side than on a rear side and free from any horizontal part and any recess. Water adhering to the plate body 21 flows toward a front side of the plate body 21 by the plate gradient PR. The water having reached an end edge of the plate body 21 falls along the linking portion 27 and flows down toward the outside of the cover plate 20.

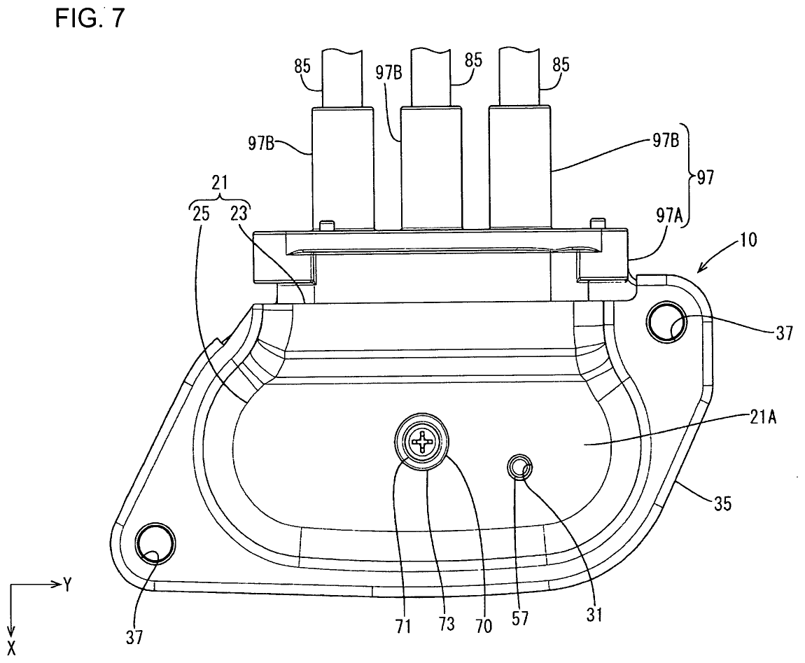

As shown in FIGS. 6 and 7, the mounting portion 35 covers the flange 95. The mounting portion 35 has substantially the same outer shape as the flange 95 and a side surface 35A of the mounting portion 35 formed by bending an end part of the mounting portion 35 has a vertical dimension equivalent to a plate thickness of the flange 95 and completely covers the flange 95. The mounting portion 35 is provided with bolt holes 37 concentric with the bolt insertion holes 95A of the flange 95.

The plug body 40 is made of synthetic resin and includes, as shown in FIGS. 3 and 4, a fitting 41 fittable into the opening 91 (see FIG. 5) and a flat plate 51 in the form of a flat plate continuous with an upper end part of the fitting portion 41. The fitting 41 has an elliptical shape in a plan view, the outer shape thereof is the same as the inner shape of the opening 91, and outer dimensions thereof are equal to or slightly smaller than inner dimensions of the opening 91. Further, a seal fitting groove 43 is formed over the entire periphery on the outer peripheral surface of the fitting 41. A sealing member 45 having an annular elliptical shape is fit in the seal fitting groove 43. One lip 45A projects outward in the sealing member 45, and an outer diameter of the lip 45A is set slightly larger than an inner diameter of the opening 91. When the fitting 41 is fit into the opening 91, the lip 45A of the sealing member 45 is squeezed and held in close contact with the inner peripheral surface of the opening 91, thereby sealing between the fitting portion 41 and the opening 91.

The flat plate 51 has a laterally long elliptical shape and substantially the same outer shape as the fitting portion 51 and is slightly larger than the fitting 41. Outer dimensions of the flat plate 51 are larger than the inner dimensions of the opening 91, and the entire flat plate 51 is located above the opening 91. The lower surface of the flat plate 51 comes into contact with an upper edge 91A (see FIG. 6) of the opening 91 to position the plug body 40 at a predetermined position of the opening 91. Further, contact portions 53 configured to come into contact with the lower surface of the plate body 21 are provided on both longitudinal (lateral) end parts of the flat plate 51. The contact portion 53 has a linear shape extending in the front-rear direction and projects upward from the flat plate 51. A projecting dimension of the contact portion 53 from the flat plate 51 is constant in the front-rear direction.

As shown in FIG. 3, the boss 55 projects up at a center position of the flat plate 51. An upper end part of the boss 55 is insertable into the insertion hole 29 of the cover plate 20 with a predetermined clearance defined between the hole edge part 29A and this upper end part. A height of the boss 55 is set such that the upper end surface of the boss 55 slightly projects from a surface of the edg 29A of the insertion hole 29 when the boss 55 is inserted into the insertion hole 29. The boss 55 has a cylindrical shape and a lower hole into which the tap screw 70 is screwed is provided from the upper surface of the boss 55 toward a rear side.

Further, as shown in FIG. 1, the positioning pin 57 in the form of a round pin projects to the right of the boss 55 of the flat plate 51. The positioning pin 57 is insertable with a predetermined clearance defined between a hole edge part of the pin insertion hole 37 in the cover plate 20 and the positioning pin 57. Further, the positioning pin 57 has such a projecting dimension as to slightly project from a surface of the cover plate 20.

As shown in FIGS. 3 and 4, an upper surface 51A of the flat plate 51 is provided with a first plug body gradient HR1 in a longitudinal direction (lateral direction) of the flat plate 51 and a second plug body gradient HR in a transverse direction (front-rear direction). The first plug body gradient HR1 is set such that a right end is highest and a position of a taper end line TL is lowest. The taper end line TL extends straight in the front-rear direction (parallel to an X axis) and is provided to the right of the boss 55 (on the side of the positioning pin 57). By providing the first plug body gradient HR1, water adhering to the flat plate portion 51 flows down to be collected at a position to the right of the boss 55. Further, the second plug body gradient HR2 is set such that a rear end is highest and a front end is lowest, and about the same as the plate gradient RP of a facing part (plug body covering portion 25) of the plate body 21. By providing the second plug body gradient HR2, water adhering to the flat plate 51 flows toward a front side of the flat plate 51 and the water having reached an end edge of the flat plate 51 flows down to the outside of the opening 91. Note that the lower end position of the upper surface 51A of the flat plate 51 is located above the upper end hole edge part 91A of the opening 91, and water flowing down from the upper surface 51A of the flat plate 51 does not intrude into the opening 91.

The opening sealing member 10 of this embodiment is structured as described above and, for example, assembled in the following procedure. First, the sealing member 45 is fit into the seal fitting groove 43 of the plug body 40. Subsequently, the plug body 40 is mounted on a lower side of the plate body 21 on the underside (lower surface side) of the cover plate 20. Specifically, the contact portions 53 of the flat plate 51 are brought into contact with the underside (lower surface) of the plate body 21 while the positioning pin 57 is inserted into the pin insertion hole 31, and the boss 55 is inserted into the insertion hole 29. At this time, since the plate gradient PR of the plug body cover 25 of the plate body 21 and the second plug body gradient HR2 are substantially equal, the underside of the plate body 21 and the contact portions 53 are held in contact from the rear ends to the front ends of the contact portions 53.

If the plug body 40 is brought in a proper posture into contact with the underside (rear surface) of the cover plate 20, the tap screw 70 can be fit and tightened into the lower hole of the boss 55. At this time, an internal thread can be cut in the lower hole of the boss 55 by the screw 75 of the tap screw 70. The tap screw 70 is screwed up to a position where the ring 73 comes into contact with the upper surface of the boss 55. At this time, since the positioning pin 57 of the plug body 40 is fit in the pin insertion hole 31 of the cover plate 20, the plug body 40 is restricted from rotating as the tap screw 70 is screwed.

A drop of the plug body 40 from the underside (rear surface) of the cover plate 20 is hindered by the contact of the ring 73 with the hole edge part 29A of the insertion hole 29 and the upper surface of the boss 55. Further, the cover plate 20 is mounted movably along an axial direction of the boss 55. Further, since clearances provided between the boss 55 and the insertion hole 29 and between the positioning pin 57 and the pin insertion hole 31, the plug body 40 is held in a state movable in all of upward, downward, leftward and rightward directions.

After the opening sealing member 10 is assembled as described above, the opening sealing member 10 is fit to the opening 91 of the connector 80, as shown in FIG. 6. When the opening sealing member 10 is disposed at a predetermined position and the cover plate 20 is pressed toward the connector 80, the plug body 40 is pushed into the opening 91 while the sealing member 45 is squeezed and deformed in a circumferential direction, and the pushing is stopped when the flat plate 51 comes into contact with the upper edge 91A of the opening 91. At this time, since the plug body 40 is held in the state movable in all the directions, the plug body 40 is fit while being centered with the opening 91. The mounting portion 35 of the cover plate 20 covers the flange 95 of the connector 80 and the bolts are inserted through the bolt holes 37 and screwed into the case together with the bolt insertion holes 95A of the connector 80. Thus, the opening sealing member 10 is fixed to the upper surface of the case of the device together with the flange 95.

It is assumed that water splashes on the opening sealing member 10 with the opening 91 closed by the opening sealing member 10. If the cover plate and the plug body are provided with no gradient, the upper surfaces of the cover plate closing the opening 91 open in the vertical direction and the plug body are horizontal and the water stays thereon. However, in this embodiment, water splashed on the upper surface 21A of the plate body 21 of the cover plate 20 flows down toward the front side of the plate body 21 by the plate gradient PR. The water having reached the end edge of the plate body 21 falls down along the link 27 and flows down to the outside of the cover plate 20. Thus, it can be suppressed that the water adhering to the cover plate 20 stays on the cover plate 20 to corrode the cover plate 20.

Further, water intrudes into a gap between the cover plate 20 and the plug body 40 from a rear opening of the cover plate 20, the insertion hole 29, the pin insertion hole 31 and the like. The intruding water flows toward the front side of the flat plate 51 by the second plug body gradient HR2 while being collected toward the taper end line TL by the first plug body gradient HR1 on the upper surface 51A of the flat plate 51 of the plug body 40. At this time, since the taper end line TL and the boss 55 are shifted in position in the longitudinal direction, the boss 55 does not stand as a hindrance when the water collected toward the taper end line TL flows down toward the front side. Note that since the taper end line TL is located on the side of the boss 55 toward the positioning pin 57, a gradient on the side of the positioning pin 57 becomes steep and the water easily flows even if the positioning pin 57 is present. The water having reached the end edge of the flat plate 51 is caused to flow down to the outside of the opening 91 by two types of the plug body gradients HR1, HR2. At this time, the lower end position of the upper surface 51A of the flat plate 51 is located above the upper edge 91A of the opening 91 and the water flowing down from the upper surface 51A of the flat plate 51 does not intrude into the opening 91. Since the water intruding between the plug body 40 and the cover plate 20 is also discharged, the corrosion of the cover plate 20 and the intrusion of the water into the opening 91 can also be suppressed.

As just described, water splashed on the upper surface 21A of the plate body 21 of the cover plate 20 and water intruding between the cover plate 20 and the plug body 40 finally flow down toward the front side of the opening sealing member 10. Thus, it is sufficient to deal with the flowing-down water only on the front side. Further, since the water is caused to flow down toward the front side, the splash of the water on the wires 85 extending rearward can be suppressed.

In this embodiment, water splashed on the cover plate 20 flows down from the cover plate 20 and does not stay on the cover plate 20 since the upper surface 21A of the plate body 21 of the cover plate 20 is provided with the plate gradient PR. Further, since the water intruding between the cover plate 20 and the plug body 40 is also caused to flow down from the plug body 40 to the outside of the opening 91 by providing the plug body 40 with the plug body gradients HR1, HR2, the water does not stay between the plug body 40 and the cover plate 20. Therefore, corrosion by the intruding water can be suppressed.

The invention is not limited to the above described and illustrated embodiment. For example, the following various modes are also included.

Although the plate gradient PR of the cover plate 20 is set such that the rear end is highest and the front end is lowest in the above embodiment, the plate gradient PR may be conversely set or provided in the longitudinal direction. Further, the plate gradient PR may be such a gradient as to be high in a central part and become lower toward edge parts.

Although the first plug body gradient HR1 of the plug body 40 is set such that both ends are high and the taper end line TL is low in the above embodiment, the first plug body gradient HR1 may be such a gradient as to be high in a central part and become lower toward edge parts. Further, the taper end line TL is provided on the side of the boss 55 toward the positioning pin 57, but may be provided on an opposite side or may overlap with the boss 55. Although the second plug body gradient HR2 of the plug body 40 is set such that the rear end is high and the front end is low, the second plug body gradient HR2 may be conversely set. Further, the second plug body gradient HR2 may be such a gradient as to be high in a central part and become lower toward edge parts. Furthermore, only either one of the first plug body gradient HR1 and the second plug body gradient HR2 may be provided.

Although the mounting portion 35 is provided with no gradient in the above embodiment, the flange 95 and the mounting portion 35 may be provided with gradients.

Although the mounting portion 35 covers the entire flange 95 in the above embodiment, the mounting portion 35 may be provided only at the position of the bolt insertion hole 95A.

Although the plate gradient PR of the cover plate 20 and the second plug body gradient HR2 of the plug body 40 are in the same direction and have the same angle in the facing parts in the above embodiment, these gradients may be in different directions and may have different angles in the facing parts.

Although water is caused to flow toward a side opposite to the side where the wires 85 extend in the above embodiment, the water flowing side may not be the opposite side.

Although the opening 91 is provided in the housing 90 of the connector 80 in the above embodiment, the opening 91 may be provided in the metal case or the like.

Although the flat plate 51 having larger external dimensions than the fitting 41 is provided in the above embodiment, the external dimensions of the flat plate may be equal to or smaller than that of the fittings 41. It is sufficient that the lower end position of the upper surface of the plug body is located above the upper end surface of the opening 91.
10 . . . opening sealing member
20 . . . cover plate
21 . . . plate body
21A . . . upper surface
29 . . . insertion hole
31 . . . pin insertion hole
35 . . . mounting portion
40 . . . plug body
41 . . . fitting
51 . . . flat platen
51A . . . upper surface
55 . . . boss
57 . . . positioning pin
70 . . . tap screw
80 . . . connector (electrical device)
81 . . . terminal
85 . . . wire
90 . . . housing
91 . . . opening
PR . . . plate gradient
HR1 . . . first plug body gradient
HR2 . . . second plug body gradient
TL . . . taper end line

1. An opening sealing member for closing an opening for work open in a vertical direction, comprising:
a cover plate configured to cover the opening from above; and
a plug body held on the cover plate and including a sealing member to be held in close contact with an inner peripheral surface of the opening by the plug body being fit into the opening;
wherein:
an upper surface of the cover plate is provided with a gradient to cause water adhering to the cover plate to flow down to outside of the cover plate; and
an upper surface of the plug body is provided with a gradient to cause water adhering to the upper surface of the plug body to flow down to outside of the opening.

2. The opening sealing member of claim 1, wherein the upper surface of the cover plate and the upper surface of the plug body are provided with the gradients in the same direction.

3. The opening sealing member of claim 1, wherein
a boss used to screw a bolt for fixing the plug body to the cover plate is provided to project on the plug body;
the plug body has an elliptical shape in a plan view and the upper surface of the plug body is provided with a first plug body gradient in a longitudinal direction and a second plug body gradient in a transverse direction; and
a lower end position of the first plug body gradient is shifted in the longitudinal direction from a position where the boss portion is provided.

4. An electrical device, comprising:
the opening sealing member of claim 1;
a terminal;
a wire connected to the terminal; and
a housing configured to accommodate the terminal and provided with an opening for work, the opening being closed by the opening sealing member;
wherein lower end positions of gradients provided on upper surfaces of the cover plate and the plug body are located on an end part opposite to a side where the wire is pulled out.
